(19) United States
(12) Patent Application Publication
(10) Pub. No.: US 2005/0222287 A1
(43) Pub. Date: Oct. 6, 2005

(54) Electronically controlled direct injection foam delivery system and method of regulating flow of foam into water stream based on conductivity measure

(76) Inventor: Geary E. Roberts, Glendale, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/087,340

(22) Filed: Mar. 22, 2005

Related U.S. Application Data
(60) Provisional application No. 60/558,347, filed on Mar. 31, 2004.

(51) Int. Cl. C08K 3/00

(52) U.S. Cl. 521/131

(57) ABSTRACT

Fire fighting equipment uses an electronically controlled direct injection foam delivery system (10). A water pump (14) pumps water through a pipe (24). A foam pump (36) pumps foam into a mixing chamber (46) within the pipe to produce a water-foam mixture. A microprocessor-based control circuit (20) controls the water pump and foam pump. A conductivity sensor (50) is coupled in-line with the pipe for monitoring conductivity of the mixture and providing a feedback signal to the control circuit to regulate the foam pump. The conductivity sensor uses stainless steel plates (60,62) positioned in the flow stream of the pipe for measuring conductivity of the mixture. An interface circuit (54) generates a voltage having dual polarity and a fifty percent duty cycle for the conductivity sensor. A second conductivity sensor (30) monitors conductivity of the water and provides a feedback signal to the control circuit.

### Claim to Domestic Priority

The present non-provisional patent application claims priority to provisional application Ser. No. 60/558,347 entitled “Electronically Controlled Direct Injection Foam Delivery System and Method of Regulating Flow of Foam into Water Stream based on Conductivity Measure”, filed on Mar. 31, 2004, by Geary E. Roberts.

### FIELD OF THE INVENTION

The present invention relates in general to electronically controlled direct injection fluid mixing and delivery systems and, more particularly, to a system of mixing foam concentrate into a water stream while maintaining proportionately constant final mixture of the water and foam based on conductivity measure during fire fighting activities.

### BACKGROUND OF THE INVENTION

Fire fighting equipment and processes are an essential part of public safety and protection of property. Fire fighting departments are organized under city, county, and private companies and brigades. The fire fighting departments use a variety of equipment, and provide training to fire fighters in proper use of such equipment in fighting fires, fire prevention, and personal and public safety.

Fire fighting equipment is often classified by the type of flammable material which it is most effective against. Class A fires and related equipment involve solid combustibles, building materials, structures, rubbish, vehicles, industrial, marine, wildlands, and the like. Class B fires relate to flammable liquids, Class C fires are electrical fires, and Class D fires involve combustible metals. Water alone is often not the most efficient and effective fire-extinguishing medium. Water addresses only the heat portion of the heat-fuel-oxygen fire triangle. In most situations, Class A foam, which contains water, is more effective in extinguishing the flames. Class A foam contains a surface active agent, which reduces the surface tension of the water, allowing it to better penetrate into the fuel surface. The foam bubbles cling to the fuel surface, isolating the fuel from the heat and oxygen. The water droplets in Class A foam are smaller than in a conventional water fog spray pattern, which provides for a more rapid conversion to steam when applied to a fire, resulting in better heat absorption.

The water and foam must have the proper mixture or percent concentration of foam in the water stream. The water has a flow rate as determined by the pressure and diameter of pipe. The water further has a certain conductivity based on the mineral, foreign matter, or particulate content, also known as hardness, of the water source. The foam is pumped from a tank or reservoir and injected into the water stream. The flow rate of the foam must proportionately match the flow rate of the water stream and take into account the conductivity of the water source in order to produce an effective foam concentration in the water stream as projected onto the fire.

Conventional electronic direct injection foam proportioning equipment is based on the volumetric process using the water flow rate as measured by a turbine-flow meter for the foam delivery system. The foam concentrate flow rate is adjusted either manually or automatically to the desired percentage of the water flow. The foam is introduced into the water stream according to the water flow rate.

However, there exist a number of variables in the various electronic direct injection foam delivery systems that can lead to an inaccurate ratio of foam concentration in the water stream as projected onto the fire. Volumetric flow-based electronic foam proportioners do not automatically adjust for varying water hardness, which affects the quality of the finished foam mixture. The foam proportioners also do not automatically adjust for the variation in the detergent strength of the commercially available foam concentrates, which also greatly affects the quality of the finished foam. Some utilize a motor-mounted velocity feedback sensor, which may not accurately represent the actual foam concentrate flow. The velocity of the water flow rate and the foam concentration in the water stream are in fact independent variables, which relate only when the system is working perfectly. The foam pump could even run dry or pump the wrong liquid and the proportioner will continue to function as though it were operating correctly.

In some situations, e.g. when responding to a large fire, there may not be a fire hydrant in proximity to the blaze or, due to inadequate water pressure, it may be necessary to tap into supplemental water sources to provide the necessary flow to extinguish the fire. Water may be supplied from an alternate source such as a fire tanker or drafted from a nearby body of water. The water stored in the truck's tanks or drafted from a body of water may not have the same conductivity characteristics as the water available from the hydrant water system. Moreover, the conductivity of water is known to vary from location to location. Variation in water conductivity will likely lead to incorrect foam concentration or foam effectiveness in the water stream as projected onto the fire.

A need exists for a foam delivery system which accounts for variation in water and foam concentrate conductivity, and overcomes potential miscalibrations in proportioning equipment.

### SUMMARY OF THE INVENTION

In one embodiment, the present invention is a unit of fire fighting equipment having a direct injection foam delivery system comprising a water pump for pumping water through a pipe. A foam pump is coupled to the pipe for mixing foam with the water and producing a mixture. A control circuit controls the foam pump. A conductivity sensor is coupled in-line with the pipe for monitoring conductivity of the mixture and providing a mixture conductivity signal to the control circuit to regulate the foam pump.

In another embodiment, the present invention is a mixing system comprising a pump which directs a chemical agent into a pipe for mixing with a liquid and producing a mixture. A control circuit controls the pump. A conductivity sensor is coupled to the pipe for monitoring conductivity of the mixture and providing a mixture conductivity signal to the control circuit to regulate the pump.

In yet another embodiment, the present invention is a method of mixing first and second fluids comprising transporting a first fluid through a conduit under pressure, mixing a second fluid with the first fluid to produce a mixture, sensing conductivity of the mixture, and regulating flow of the second fluid in response to the sensed conductivity of the mixture.

### BRIEF DESCRIPTION OF THE DRAWINGS

FIG. 1 illustrates fire fighting equipment with electronically controlled direct injection foam delivery system;

FIG. 2 is a block diagram of the electronically controlled direct injection foam delivery system;

FIG. 3 illustrates further detail of the mixture conductivity sensor;

FIG. 4 illustrates further detail of the conductivity sensor interface circuit;

FIG. 5 illustrates foam delivery subsystem using high volume motor and low volume motor;

FIG. 6 illustrates foam delivery subsystem using high volume pump and low volume pump; and

FIG. 7 illustrates foam delivery subsystem accessing different foams from different tanks.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

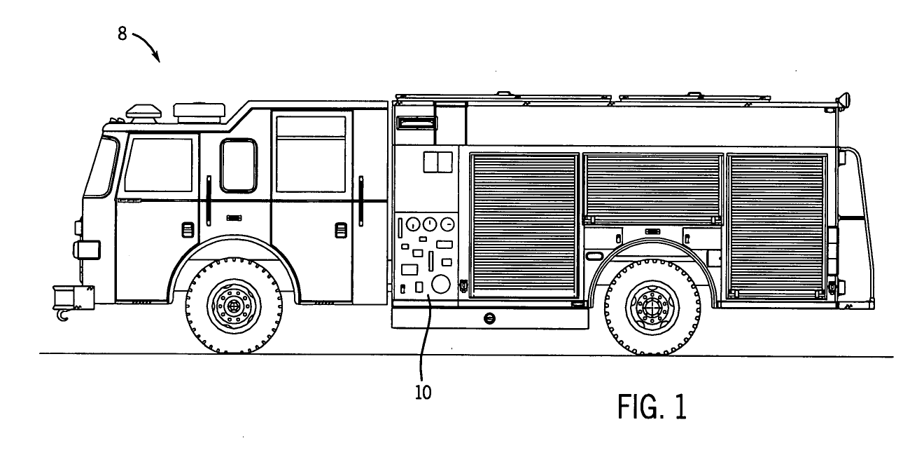

Referring to FIG. 1, a fire truck 8 is shown as a unit of fire fighting equipment with electronically controlled direct injection foam delivery system 10 mounted within the fire truck. Fire truck 8 contains a number of compartments and support frames for housing the foam delivery system. Electronically controlled direct injection foam delivery system 10 may also be mounted on fireboats, airplanes, helicopters, and portable fire fighting equipment.

Foam delivery system 10 is direct injection, electronically controlled and uses conductivity sensing to regulate foam concentration in the water stream for fire fighting applications. Fire fighting departments, companies, and brigades operating in urban and rural settings use the equipment shown in FIG. 1 to fight fires and maintain personal and public safety. Conductivity-based electronically controlled direct injection foam delivery system 10 provides substantial advantages over prior foam delivery systems.

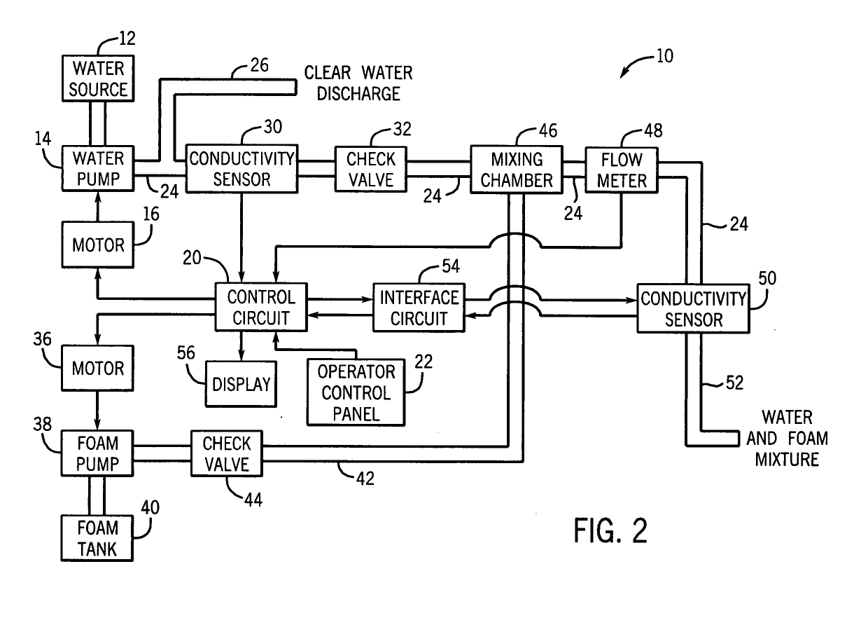

A block diagram of electronically controlled direct injection foam delivery system 10 is shown in FIG. 2. A manual valve or pressure regulator sets the water flow rate from water source 12 into pipe 24. Water source 12 may be a fire hydrant, tanker truck, or fixed body of water. Alternately, water from water source 12 can be pumped by water pump 14. In this case, motor 16 is the prime mover to operate water pump 14. Motor 16 is typically a diesel or gasoline combustion engine but may be implemented as an electric motor. Motor 16 has a separate operator control panel or receives control signals from control unit 20. Control unit 20 contains a microprocessor or other logic circuits for processing operator commands, receiving sensor information, and generating control signals. Control circuit 20 contains non-volatile memory storage capacity. Control unit 20 further includes pulse width modulated (PWM) driver circuits to control devices such as motor 16 and motor 36.

The system operator, e.g., fire truck engineer, can set controls manually with hand-operated valves and levers, or enters commands by way of operator control panel 22. The system operator enters the foam proportioning ratio in terms of percentage of foam concentrate in the water through operator control panel 22. Control circuit 20 receives the water pump flow rate command and generates the PWM control signal to motor 16, which in turn spins water pump 14 to draw water from water source 12. Water pump 14 pumps water into pipe, manifold, hose, or conduit 24 at the specified flow rate. Water pump 14 may also pump out clear water discharge, i.e., no foam content, by way of manifold 26.

The water stream has a flow rate determined by the pressure introduced by water pump 14 and the diameter of pipe or hose 24. The water also has certain electrochemical properties, known as conductivity, which is a measure of the mineral, foreign matter, particulate content, or hardness of the water source. The water conductivity changes based on the location, region, and source of the water. The water hardness may vary from de-ionized water, i.e., substantially no particulates, to very harsh water such as seawater. Conductivity sensor 30 is placed in-line in pipe 24 to measure the conductivity of water in pipe 24. Conductivity sensor 30 is a precision mohms conductivity sensor. Conductivity sensor 30 measures the conductivity value of the water prior to introduction of foam concentrate. The conductivity measure is sent to control circuit 20 for providing a baseline or reference point of water conductivity. The baseline water conductivity reference point is continuously updated in control circuit 20 by conductivity sensor 30. Check valve 32 is also placed in-line in pipe 24 to prevent any reverse flow in pipe 24 back toward conductivity sensor 30.

Control circuit 20 also sends a PWM control signal to motor 36. Motor 36 is the prime mover to operate foam pump 38. Motor 36 is typically an electric motor, but may be implemented as a diesel or gasoline combustion engine, water driven motor, or hydraulically driven motor. Foam pump 38 draws foam concentrate or other fire retardant or chemical agent from foam tank 40.

Control circuit 20 generates the PWM control signal to motor 36, which in turn spins foam pump 38 to draw foam from tank 40. Foam pump 38 pumps foam concentrate into pipe 42 at the specified flow rate. Check valve 44 may be placed in-line in pipe 42 to prevent any reverse flow from pipe 42 back into foam pump 38.

Mixing chamber 46 directly injects the foam concentrate from pipe 42 into the main water stream in pipe 24. Mixing chamber 46 may be a pipe union, “T”, or “Y” connecting pipe 42 into the main stream pipe 24. Alternatively, mixing chamber 46 may provide a circular or turbulent mixing operation to thoroughly blend and mix the foam concentrate into the water stream.

Flow meter 48 is placed in-line in pipe 24. Flow meter 48 is an impeller or paddle wheel driven velocity flow sensor which monitors the flow rate of the water-foam mixture in pipe 24 following mixing chamber 46. The flow meter reading is sent to control circuit 20 to provide a real-time measure of the water flow rate. Flow meter 48 may be placed anywhere along pipe 24.

The water-foam mixture in pipe 24, following mixing chamber 46, contains a certain percentage or concentration of foam based on the foam flow rate from foam pump 38 and the water flow rate from water pump 14. The water-foam mixture also has conductivity as determined by the conductivity of foam in the water stream and the conductivity of the water.

The mixture must maintain the proper ratio of foam and water to be effective as a fire fighting agent. By knowing the conductivity of the water, and conductivity of the water-foam mixture, the percent concentration of the foam in the water can be determined. In other words, the conductivity of the water-foam mixture is an indicator of the percent concentration of the foam in the water stream necessary to maintain the effectiveness of the water-foam mixture as a fire fighting agent.

Conductivity sensor 50 is placed in-line with pipe 24 to measure the conductivity of the water-foam mixture or foam solution. Conductivity sensor 50 sends signals to and receives signals from control circuit 20 by way of interface circuit 54.

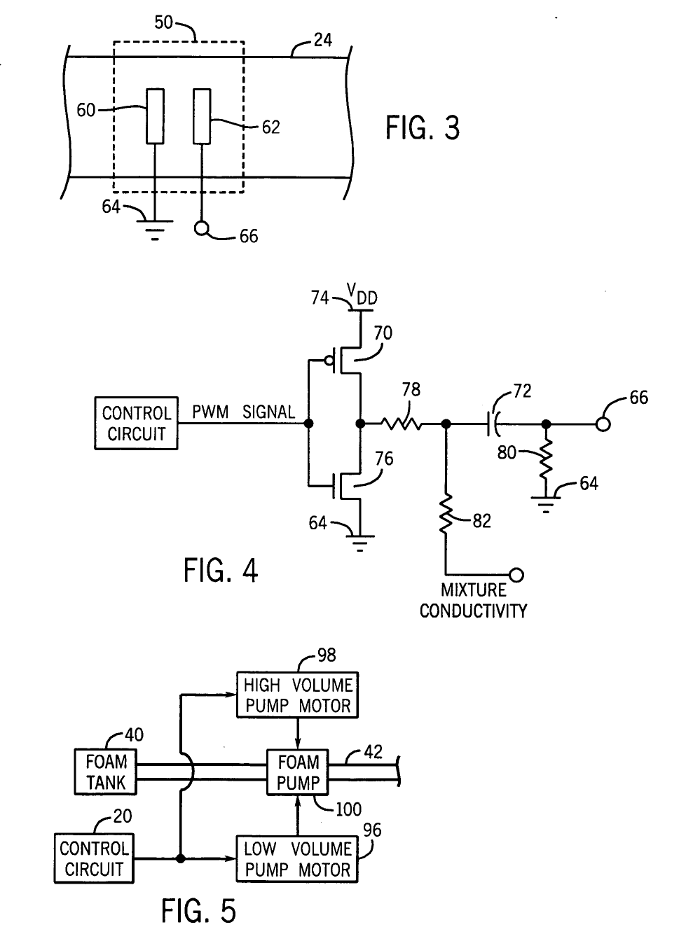

Further detail of conductivity sensor 50 is shown in FIG. 3. Conductivity sensor 50 is a precision mohms conductivity sensor positioned in-line with pipe 24 after mixing chamber 46 in order to read and report the conductivity of the combined fluids. Conductive plate or wires 60 and 62 are placed in the flow stream of pipe 24. Plates 60 and 62 are made with stainless steel or other non-corrosive metal, and have identical and equal mass. Plate 60 is coupled to ground with conductor 64, and plate 62 is coupled to conductor 66.

The interface circuit 54 is shown in FIG. 4. Control circuit 20 provides a PWM signal operating at known frequency and precise 50% duty cycle. When the PWM signal is logic zero, p-channel field effect transistor 70 conducts and charges capacitor 72 through resistor 78 with the voltage on power supply conductor 74. Capacitor 72 is selected as a 100 microfarad, 10% variance, electrolytic capacitor. The power supply conductor 74 operates at V_{DD}=10 volts DC. When the PWM signal is logic one, n-channel field effect transistor 76 conducts and charges capacitor 72 through resistor 78 with the voltage on power supply conductor 78. The power supply conductor 78 operates at ground potential. When the plate of capacitor at the junction between transistors 70 and 76 is pulled to ground, the voltage on the other plate of capacitor 72, i.e., on conductor 66, reverses polarity. The voltage on conductor 66 as developed across resistor 80 alternates from +10 volts DC to −10 volts DC with the frequency and duty cycle of the PWM signal.

While the voltage on conductor 66 swings from +10 volts DC to −10 volts DC, the steady state differential voltage on plates 60 and 62 remains a constant 10 volts. The 50% duty cycle of the differential voltage reduces electroplating effects on plates 60 and 62. Without the precise 50% duty cycle, the minerals, impurities, and particulate content of the water-foam mixture would plate onto plates 60 and 62, causing errors in the conductivity reading and maintenance problems.

The conductivity measure is provided through resistor 82 as the MIXTURE CONDUCTIVITY signal, which is sent to an analog to digital converter within control circuit 20 in FIG. 2 to sample the voltage on conductor 66. The voltage is measured at the high point, i.e., when conductor 66 is +10 volts DC, and again measured at the low point, i.e., when conductor 66 is −10 volts DC. The high point above ground is the same proportion as the low point below ground. The high measurement is subtracted from the low measurement to give a difference or offset resistance value, which is proportional to the conductivity of the water-foam mixture. The offset resistance value is representative of and proportional to the titration of the water-foam mixture.

The resistance measurement between plates 60 and 62 is determined by the electrochemical conduction properties of the water-foam mixture in pipe 24. The greater the concentration of impurities and particulate content in the water-foam mixture, the greater the conductivity measurement. The lesser the concentration of impurities and particulate content in the water-foam mixture, the lesser the conductivity measurement.

The concentration of impurities and particulate content in the water-foam mixture is a function of the percent concentration of foam in the water stream and the base conductivity of the water. Assuming a known conductivity of water, i.e. as provided by conductivity sensor 30, the greater the conductivity measurement, the greater the percent concentration of foam in the water stream. The lesser the conductivity measurement, the lesser the percent concentration of foam in the water stream. The resistance measure between plates 60 and 62 is directly related to the conductivity of the water-foam mixture, which in turn is directly related to the percent concentration of foam in the water stream. The greater the resistance measurement, the greater the conductivity measurement and the greater the percent concentration of foam in the water stream. The lesser the resistance measurement, the lesser the conductivity measurement and the lesser the percent concentration of foam in the water stream.

Returning to FIG. 2, a mixture conductivity signal representative of the conductivity of the water-foam mixture is sent to control circuit 20. Control circuit 20 uses the mixture conductivity signal, in combination with the measure of the water conductivity from conductivity sensor 30, to control motor 36 to increase or decrease the flow rate of foam pump 38 to maintain the conductivity of the water-foam mixture in pipe 24 within a proper range. As the conductivity of the water-foam mixture increases or decreases from its set value, foam pump 38 adjusts the foam flow rate to compensate, re-establish, and maintain the desired percent concentration of foam in the water steam. Conductivity sensor 50 provides feedback information based on conductivity measure which is representative of the actual foam concentration in the water to regulate the flow rate of foam pump 38. The proper conductivity range of the water-foam mixture translates to the correct percent concentration of foam in the water stream. The water-foam mixture having the correct percent concentration of foam is projected from manifold 52 to effectively fight fires.

In one embodiment, the foam fire retardant in foam tank 40 is a class A foam available under various trade names. Class A foam is useful for fires involving solid combustibles, building materials, structures, rubbish, vehicles, industrial, marine, wildlands, and the like. Other classes of foam can be stored in foam tank 40 and used with system 10. For example, class B foam is used for flammable liquid fires, class C foam is more effective against electrical fires, and class D foam is best suited for combustible metals. Tank 40 may contain other fire retardants and chemical agents.

Fires require heat, oxygen, and fuel, known as the fire triangle, to continue burning. Water alone reduces the heat portion of the fire triangle. A water-foam mixture offers the advantage of attacking all three legs of the fire triangle. The foam coats the fuel and isolates the heat and oxygen. The foam also reduces water droplet size to more effectively reduce heat. For many types of fires, the use of water-foam mixture extinguishes fires more quickly, requires less water, reduces property damage, and preserves evidence.

Consider the following operational description of electronically controlled direct injection foam delivery system 10. Once the water pump flow rate has been set manually or through operator control panel 22, the system operator next enters and stores a conductivity set point into the memory of control circuit 20. The water volume flow rate and conductivity set point or foam concentration level are displayed on display 56 to provide information as to system settings. The conductivity set point is representative of the intended conductivity of the final proportionate water-foam mixture and determines the percentage or concentration of foam in the water stream of pipe 24. A higher conductivity set point translates to a higher percent concentration of foam in the water stream; a lower conductivity set point corresponds to a lower percent concentration of foam in the water stream. The conductivity set point is an accurate measure of the total titration of the water-foam mixture and, by direct relationship, the actual concentration of foam in the water stream. The conductivity of the water-foam mixture in pipe 24 changes in proportion to the foam concentration.

The relationship between conductivity of the water-foam mixture and the percent concentration of foam in the water stream is determined in a calibration process. A known manufacturer and quality of foam concentrate is used as a benchmark. The calibration process measures conductivity of the water-foam mixture over a range of foam concentrations. The foam concentrations, ranging from 0.1% to 3.0% of concentrate in solution in steps of 0.1%, are established in the water stream of pipe 24. At each known step of solution concentration, the conductivity is measured. The process is repeated for a range of water conductivity levels. A table of conductivity measures and corresponding foam concentrations for each level of water-only conductivity is created and stored in the memory of control circuit 20.

The conductivity of the water-foam mixture is measured by conductivity sensor 50 and sent to control circuit 20 where the conductivity value of the final discharge mixture is compared with the operated-entered conductivity set point according to the conductivity table. Conductivity sensor 30 provides the present water-only conductivity measure. Conductivity sensor 30 is implemented as described for conductivity sensor 50. For a specific water conductivity, the conductivity table translates to the conductivity set point for the desired foam concentration in the water-foam mixture. If the measured conductivity from conductivity sensor 50 is less than the conductivity set point, then control circuit 20 causes motor 36 to increase the flow rate of the foam from pump 38. If the measured conductivity from conductivity sensor 50 is greater than the conductivity set point, then control circuit 20 causes motor 36 to decrease the flow rate of the foam from pump 38. By measuring the actual conductivity of the water-foam mixture in pipe 24 and comparing the measured conductivity value to an operator-entered conductivity set point, for the given water conductivity, control circuit 20 can maintain the correct percent concentration in foam in the water stream for discharge from manifold 52. The feedback system compensates for errors, misalignment, and mis-calibrations in system 10 and achieves a proper foam concentration to effectively and efficiently fight fires and at the same time reducing foam concentrate waste.

Control circuit 20 produces an audible or visual alarm if it is unable to correct the conductivity of the water-foam mixture to match the conductivity set point by altering the foam pump flow rate. The operator can check the system for problems; perhaps the foam tank is empty or contains the wrong product.

Turning to FIG. 5, an alternate embodiment of foam pump 38 is shown including low volume motor 96 and high volume motor 98 driving a common foam pump 100. The dynamics of foam pump 38 being driven by a single high volume motor 36 are such that it becomes difficult to maintain accurate titration in the water-foam mixture at low water flow rates and low percent foam concentrations, due to the inability to sufficiently and accurately slow down the high flow pump motor. To solve the low water flow rate and low percent foam concentration problem, control circuit 20 selects either low volume motor 96 or high volume motor 98 to drive foam pump 100 based on the titration set point and water flow rate. The water flow rate is determined by flow meter 48. Low volume motor 96 is used when the titration has a low set point, e.g., on the order of 0.3% foam at 10 GPM water flow rate. Control circuit 20 controls low volume motor 96 to set the flow rate of foam pump 100. High volume motor 98 is used at higher titration set points and water flow rates. Control circuit 20 controls high volume motor 98 to set the flow rate of foam pump 100.

The conductivity of the water-foam mixture is measured by conductivity sensor 50 and sent to control circuit 20 where the conductivity value of the final discharge mixture is compared with the operated-entered conductivity set point according to the conductivity table. For low titration levels and low water flow rates, if the measured conductivity from conductivity sensor 50 is less than the conductivity set point, then control circuit 20 causes low volume motor 96 to increase the flow rate of the foam from pump 100. Again, for low titration levels and low water flow rates, if the measured conductivity from conductivity sensor 50 is greater than the conductivity set point, then control circuit 20 causes low volume motor 96 to decrease the flow rate of the foam from pump 100. For higher titration levels and higher water flow rates, if the measured conductivity from conductivity sensor 50 is less than the conductivity set point, then control circuit 20 causes high volume motor 98 to increase the flow rate of the foam from pump 100. Again, for higher titration levels and higher water flow rates, if the measured conductivity from conductivity sensor 50 is greater than the conductivity set point, then control circuit 20 causes high volume motor 98 to decrease the flow rate of the foam from pump 100.

By measuring the actual conductivity of the water-foam mixture in pipe 24 and comparing the measured conductivity value to an operator-entered conductivity set point, for the given water conductivity, control circuit 20 can maintain the correct percent concentration in foam in the water stream for discharge from manifold 52. Control circuit 20 automatically selects between the low volume pump motor 96 and the high volume motor 98. The low volume motor 96 driving foam pump 100 is better suited for the low titration levels and low water flow rates. The high volume motor 98 driving foam pump 100 is better suited for the higher titration levels and higher water flow rates.

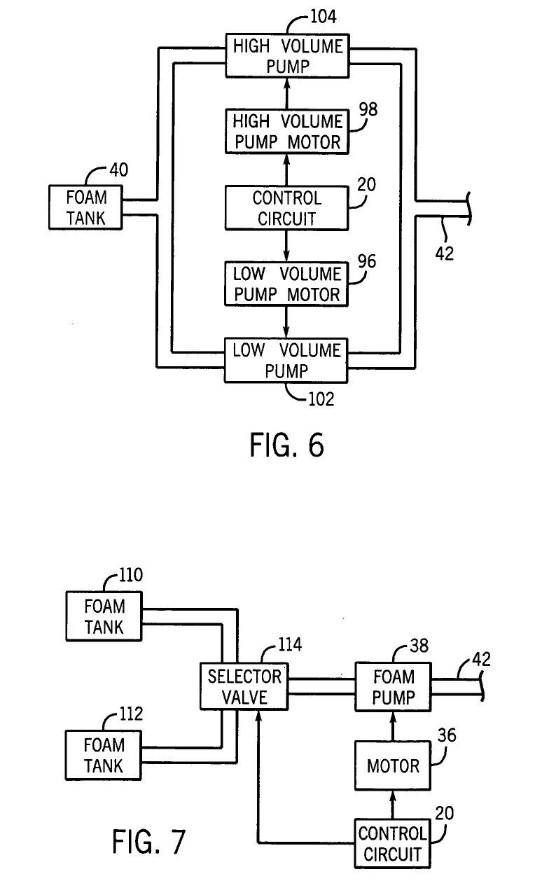

In FIG. 6, the low volume motor 96 drives a low volume foam pump 102 and the high volume motor 98 drives a high volume foam pump 104. Control circuit 20 selects either low volume motor 96 or high volume motor 98 based on the titration set point and water flow rate. Again, the water flow rate is determined by flow meter 48. Low volume motor 96 and low volume foam pump 102 are used when the titration has a low set point, e.g., on the order of 0.3% foam at 10 GPM water flow rate. Control circuit 20 controls low volume motor 96 to set the flow rate of low volume foam pump 102. High volume motor 98 and high volume foam pump 104 are used at higher titration set points and water flow rates. Control circuit 20 controls high volume motor 98 to set the flow rate of high volume foam pump 104.

In FIG. 7, foam tank 110 contains a first type of foam, e.g., class A foam, and foam tank 112 contains a second type of foam, e.g., class B foam. Selector valve 114 selects between foam tank 110 and foam tank 112. Control circuit 20 control selector valve 114 in response to system operator input via operator control panel 22. Control circuit 20 further controls motor 36 to spin foam pump 38 to pump the selected foam through pipe 42. The dual foam tank system can be used with the dual volume pump system discussed in FIG. 5 or 6.

While the present discussion is directed to water and fire retardant foam, the direct injection delivery system 10 is also applicable to other fluids, liquids, and chemical agents where the relationship of the conductivity measurements of the two fluids is representative of the final combined mixture.

1. A unit of fire fighting equipment having a direct injection foam delivery system, comprising:
a water pump for pumping water through a pipe;
a foam pump coupled to the pipe for mixing foam with the water and producing a mixture;
a control circuit for controlling the foam pump; and
a first conductivity sensor coupled in-line with the pipe for monitoring conductivity of the mixture and providing a mixture conductivity signal to the control circuit to regulate the foam pump.

2. The unit of fire fighting equipment of claim 1, further including a second conductivity sensor coupled in-line with the pipe for monitoring conductivity of the water and providing a water conductivity signal to the control circuit.

3. The unit of fire fighting equipment of claim 1, further including a mixing chamber coupled for receiving the water and the foam and producing the mixture.

4. The unit of fire fighting equipment of claim 1, wherein the control circuit includes a microprocessor coupled for receiving the mixture conductivity signal and generating control signals to regulate the foam pump.

5. The unit of fire fighting equipment of claim 1, wherein the first conductivity sensor includes first and second plates positioned in the flow stream of the pipe for measuring conductivity of the mixture.

6. The unit of fire fighting equipment of claim 1, further including an interface circuit coupled between the first conductivity sensor and the control circuit for generating a voltage having dual polarity and a fifty percent duty cycle.

7. The unit of fire fighting equipment of claim 1, wherein the foam pump includes:
a first foam pump providing a first range of flow rates in response to the control circuit and having an output coupled to the pipe; and
a second foam pump providing a second range of flow rates in response to the control circuit and having an output coupled to the pipe, the second range of flow rates being greater than the first range of flow rates.

8. The unit of fire fighting equipment of claim 7, wherein the control circuit enables the first foam pump or the second foam pump to provide the foam to the pipe.

9. The unit of fire fighting equipment of claim 1, further including:
a first foam tank for providing a first foam to the pipe to mix with the water; and
a second foam tank for providing a second foam to the pipe to mix with the water.

10. A mixing system, comprising:
a pump for directing a chemical agent into a pipe for mixing with a liquid and producing a mixture;
a control circuit for controlling the pump; and
a first conductivity sensor coupled to the pipe for monitoring conductivity of the mixture and providing a mixture conductivity signal to the control circuit to regulate the pump.

11. The mixing system of claim 10, further including a second conductivity sensor coupled in-line with the pipe for monitoring conductivity of the liquid and providing a liquid conductivity signal to the control circuit.

12. The mixing system of claim 10, further including a mixing chamber coupled for receiving the liquid and the chemical agent and producing the mixture.

13. The mixing system of claim 10, wherein the control circuit includes a microprocessor coupled for receiving the mixture conductivity signal and generating control signals to regulate the pump.

14. The mixing system of claim 10, wherein the first conductivity sensor includes first and second plates positioned in the flow stream of the pipe for measuring conductivity of the mixture.

15. The mixing system of claim 10, further including an interface circuit coupled between the first conductivity sensor and the control circuit for generating a voltage having dual polarity and a fifty percent duty cycle.

16. The mixing system of claim 10, wherein the pump includes:
a first pump providing a first range of flow rates in response to the control circuit and having an output coupled to the pipe; and
a second pump providing a second range of flow rates in response to the control circuit and having an output coupled to the pipe, the second range of flow rates being greater than the first range of flow rates.

17. The mixing system of claim 16, wherein the control circuit enables the first pump or the second pump to provide the chemical agent to the pipe.

18. The mixing system of claim 10, further including:
a first tank for providing a first chemical agent to the pipe to mix with the liquid; and
a second tank for providing a second chemical agent to the pipe to mix with the liquid.

19. A system for mixing first and second fluids, comprising:
a conduit for transporting the first under pressure, wherein the second fluid is injected into the conduit for producing a mixture of the first and second fluids;
a control circuit for controlling a flow rate of the second fluid; and
a first conductivity sensor for monitoring conductivity of the mixture and providing a mixture conductivity signal to the control circuit.

20. The system of claim 19, further including a second conductivity sensor coupled in-line with the conduit for monitoring conductivity of the first fluid and providing a fluid conductivity signal to the control circuit.

21. The system of claim 19, further including a mixing chamber coupled in the conduit for receiving the first and second fluids and producing the mixture.

22. The system of claim 19, wherein the first conductivity sensor includes first and second plates positioned in the flow stream of the conduit for measuring conductivity of the mixture.

23. The system of claim 19, further including an interface circuit coupled between the first conductivity sensor and the control circuit for generating a voltage having dual polarity and a fifty percent duty cycle.

24. A method of mixing first and second fluids, comprising:
transporting a first fluid through a conduit under pressure;
mixing a second fluid with the first fluid to produce a mixture;
sensing conductivity of the mixture; and
regulating flow of the second fluid in response to the sensed conductivity of the mixture.

25. The method of claim 24, further including:
sensing conductivity of the first fluid; and
regulating flow of the second fluid in part in response to the sensed conductivity of the second fluid.

26. The method of claim 24, wherein the step of mixing the first and second fluids includes injecting the first and second fluids into a mixing chamber to produce the mixture.

27. The method of claim 24, further including:
enabling a first pump having a first range of flow rates for transporting the second fluid; and
enabling a second pump having a second range of flow rates for transporting the second fluid, the second range of flow rates being greater than the first range of flow rates.
